(19) United States
(12) Patent Application Publication
(10) Pub. No.: US 2026/0141602 A1
(43) Pub. Date: May 21, 2026

(54) SPEECH INPUT BASED AVATAR FACE ANIMATION

(71) Applicant: Snap Inc., Santa Monica, CA (US)

(72) Inventors: Tal Pais, Tel Aviv (IL); Nir Malbin, Shoham (IL); Itamar Berger, Hod Hasharon (IL)

(21) Appl. No.: 18/951,454

(22) Filed: Nov. 18, 2024

(51) Int. Cl. G06T 13/20; G06T 13/40; G06T 19/00; G10L 25/57; G10L 25/63

(52) U.S. Cl. CPC G06T 13/205; G06T 13/40; G06T 19/006; G10L 25/57; G10L 25/63

(57) ABSTRACT

Examples relate to systems and methods for generating an avatar animation. The systems and methods access an audio file comprising speech, spoken by a user, captured by a microphone of a user system, and receive input that selects an avatar associated with the user. The systems and methods process the audio file and the avatar, selected by the received input, by a generative machine learning model to generate an animation of the avatar having lips moving to represent the avatar speaking the speech of the audio file. The systems and methods generate a video comprising a depiction of the generated animation of the avatar speaking the speech of the audio file.

### TECHNICAL FIELD

The present disclosure relates to computer graphics technologies, specifically to generative rendering engines for generating digital effects on user devices.

### BACKGROUND

Some electronics-enabled devices, such as eyewear devices, allow users to interact with virtual content (e.g., augmented reality (AR) objects or other digital effects) while a user is engaged in some activity. The virtual content can be part of a digital effects application that presents such objects over a real-world environment. Current rendering engines for computer graphics rely on physics-based principles, requiring extensive three-dimensional (3D) modeling, animation, and rigging, which is time-consuming and demands multiple experts. This traditional approach limits the ability to create highly realistic images and videos in real-time. Additionally, existing systems often require sophisticated tracking and recognition technology (which itself is imperfect), complicating the creation of realistic content.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates a diagram of a digital effects experience generation system, according to some examples.

FIG. 6 illustrates an example output of the digital effects experience generation system, according to some examples.

FIG. 7 is a flowchart illustrating a routine (e.g., a method or process), according to some examples.

FIG. 8 illustrates a system including the head-wearable apparatus, according to some examples.

FIG. 9 is a diagrammatic representation of a machine in the form of a computer system within which a set of instructions may be executed to cause the machine to perform any one or more of the methodologies discussed herein, according to some examples.

FIG. 10 is a block diagram showing a software architecture within which examples may be implemented.

### DETAILED DESCRIPTION

The description that follows discusses illustrative examples of the disclosure. In the following description, for the purposes of explanation, numerous specific details are set forth to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

Current systems for animating avatars that speak user speech rely heavily on complex tracking and recognition technology, which presents inefficiencies and resource constraints. These traditional approaches utilize sophisticated tracking and recognition technology to accurately detect and model lip movements and facial expressions in real-time, adding significant complexity to the content creation process and demanding additional expertise in computer vision and spatial computing. The implementation of such tracking systems demands specialized hardware components and software architectures that consume substantial computational resources. These systems typically require high-quality cameras for capturing visual information about lip movements, Inertial Measurement Units (IMU) for measuring movement and orientation, and powerful processors capable of handling real-time computations. Additionally, sufficient random-access memory (RAM) is needed for processing and storing the large amounts of data generated during tracking operations.

The reliance on tracking technology creates particular challenges for mobile and resource-constrained devices. The need for high-performance hardware to run complex tracking algorithms and render intricate 3D models limits the accessibility of these capabilities, such as in real-time scenarios. This constraint hinders the widespread adoption of immersive and interactive avatar experiences across various platforms and user demographics. Furthermore, these tracking-based systems struggle to adapt to different user environments and conditions without extensive setup and pre-rendering, creating a bottleneck in the production of high-quality, responsive avatar animations. The complexity of this workflow requires multiple experts working in parallel, including computer vision specialists and rendering engineers, making the process both time-consuming and resource-intensive. This inefficiency is particularly problematic in emerging fields such as AR and interactive storytelling, where the ability to generate and modify avatar animations on-the-fly is important.

The disclosed examples improve the efficiency of using the electronic device by providing a system that allows users to seamlessly generate avatar animations from speech without requiring complex tracking technology. Specifically, the disclosed techniques leverage generative machine learning models to create highly realistic avatar animations in real-time by processing an audio file that includes speech and an avatar selection to generate an animation of the avatar having lips moving to represent the avatar speaking the speech. This approach eliminates the need for traditional 3D modeling, animation, rigging, and sophisticated tracking technology that would otherwise be required to detect lip movements and facial expressions. By utilizing a generative machine learning model to process the audio and avatar inputs, the system can automatically generate photorealistic animations without having to use complex rendering and tracking systems that consume a great deal of processing and battery resources.

The system increases efficiency by utilizing only two simple inputs from the user-an audio recording of speech and a selected avatar-rather than requiring video capture and complex real-time facial tracking. This saves computational resources while making it easier and more approachable to generate artificial effects, particularly for users who may not want to expose themselves on video or prefer a faster way to create animated content. The disclosed techniques further increase the efficiencies of the electronic device by reducing the amount of information and inputs needed to accomplish avatar animation tasks and eliminating the need to run complex image processing algorithms for facial tracking on the device. This approach allows for more efficient and accessible methods of generating realistic avatar animations that can adapt to user preferences without the extensive setup required by traditional rendering engines.

The disclosed examples increase the efficiencies of the electronic device by reducing the amount of information and inputs needed to accomplish a task and reducing running complex image processing algorithms on the AR device. The disclosed examples further increase the efficiency, appeal, and utility of electronic AR devices, such as eyewear devices. While the disclosed examples are provided within a context of electronic eyewear devices, similar examples can be applied to any other type of AR wearable device, such as an AR hat, an AR watch, an AR belt, an AR ring, an AR bracelet, AR earrings, and/or an AR headset or other device that allows users to control or interact with content presented on a video or image.

### Networked Computing Environment

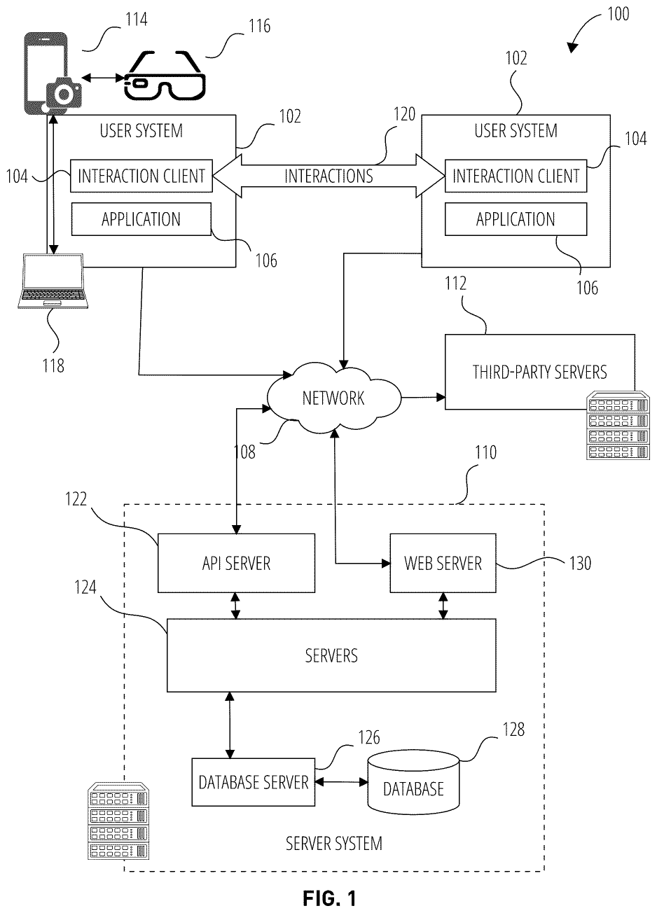

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102 (e.g., user devices) and/or head-wearable apparatus 116, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

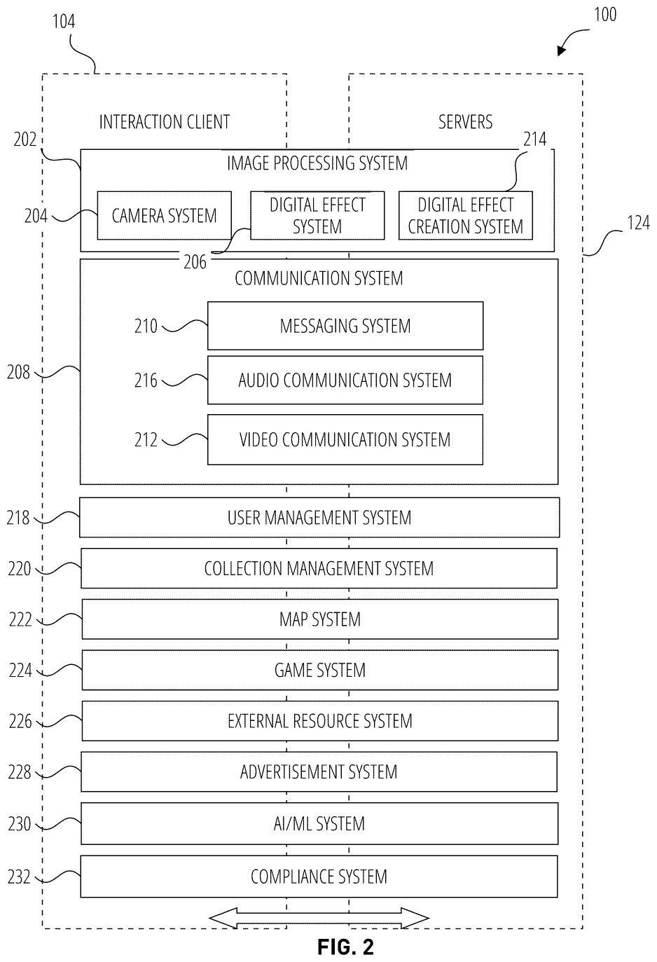

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

In some cases, the external resources include applications that enable shared or multiplayer digital effect applications or experiences and sessions on one or more head-wearable apparatuses 116. In some examples, the external resources include instructions that define functionality to implement respective digital effects experiences. These instructions can include textual prompts that are processed by local or remote implementations of generative machine learning models to generate the digital effects experiences, such as by presented artificially generated or artificially augmented video with one or more digital effects.

The disclosed examples improve the efficiency of using the electronic device by providing a system that allows users to seamlessly generate avatar animations from speech input. Specifically, the disclosed techniques leverage generative machine learning models to create highly realistic avatar animations in real-time by processing an audio file including speech captured by a microphone of a user system 102 and an avatar selection to generate an animation of the avatar having lips moving to represent the avatar speaking the speech. The system can process the audio file to detect and remove predetermined patterns of speech, such as mumbling, excluded words, or pauses, prior to processing by the generative machine learning model. The system can also translate the speech from a first language to a second language, allowing the avatar to speak the translated speech. Additionally, the system can modify the tone or style of the speech, such as changing it to a more humorous emotion, by adding, replacing, or removing words from the audio file.

The system enables users to select from multiple avatars, including avatars that have visual features representing the user or their friends. When processing the audio and avatar inputs, the generative machine learning model can simultaneously generate multiple animations of the avatar speaking in different languages based on user selection. The generated video can be integrated into digital effects experiences, including AR or virtual reality (VR) experiences, where the video can be overlaid on other content or used to replace a depiction of the actual user speaking. This approach eliminates the need for traditional tracking technology while providing enhanced functionality for modifying and customizing the avatar's speech output. The system increases efficiency by requiring only simple inputs-an audio recording and avatar selection-rather than requiring video capture and complex real-time facial tracking, making it easier and more approachable to generate artificial effects.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other

microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls camera hardware (e.g., directly or via operating system controls) of the user system 102 to modify real-time images captured and displayed via the interaction client 104.

A digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 802 of a user system 102. The digital effect system 206 can provide such functions by accessing a set of instructions associated with each respective digital effects experience and processing such instructions by video generative machine learning models in real time. The generative machine learning models can continuously process inputs and/or interactions with the rendered digital effects experiences to update presentation of the digital effects provided by the digital effects experiences. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212. A digital effect(s) application (or digital effects experience experience) is an application configured to provide and display these digital effects and can enable users to engage in multiplayer digital effects sessions using respective head-wearable apparatuses 116 or other user system 102. The digital effect application can be part of the application 106 (and/or interaction client 104) implemented by the user system 102 and/or the head-wearable apparatus 116. In some cases, the digital effect application or output representing the digital effect application can be rendered by a generative machine learning model by processing a set of instructions including prompts that define behavior, goals, and attributes of digital effects relative to real-world or virtual items presented in a video or image in real time. This way, rather than using SLAM or other real-time object tracking and modeling, the digital effects can be presented using fewer hardware and software resources by processing the instructions and generating outputs with the generative machine learning model. In some cases, the prompts can instruct the generative machine learning model (GenAI) to process an image or video of an avatar along with audio input and to generate a video that depicts the avatar (lips of the avatar) speaking speech provided by the audio input.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports AR developer platforms and includes an application for content creators (e.g., artists and developers) to create and publish digital effects (e.g., AR experiences) of the interaction client 104. The digital effect creation system 214 provides a library of built-in features and tools to content creators including, for example custom shaders, tracking technology, and templates. Any functionality that is performed by the digital effect creation system 214 can be replaced and/or augmented by processing instructions with or by a generative machine learning model. In such cases, object tracking and 3D modeling components used by the digital effect creation system 214 can be omitted or skipped as the appropriate output is rendered by the generative machine learning model.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308, and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, e.g., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a GUI (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100 including a digital effects experience generation system 504, such as an avatar selection component 516.

For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The artificial intelligence and machine learning system 230 can access a set of instructions that define an individual digital effects experience. The artificial intelligence and machine learning system 230 can then process such instructions by a generative machine learning model (in some cases along with additional user supplied inputs and/or videos/images) to render an artificial video that depicts digital effects within a real-world or virtual environment defined by the instructions. The artificial intelligence and machine learning system 230 can process such instructions by a generative machine learning model, along with an audio file including user speech and a selected avatar, to render an artificial video that depicts the avatar speaking the speech with synchronized lip movements. The generative machine learning model processes these inputs to generate an animation showing the avatar's lips moving to match the speech patterns, which can be presented within a real-world or virtual environment defined by the instructions.

Machine learning is a field of study that gives computers the ability to learn without being explicitly programmed. The artificial intelligence and machine learning system 230 can be built using machine learning models. Machine learning (e.g., machine learning models) explores the study and construction of algorithms, also referred to herein as tools, that may learn from existing data and make predictions about new data. Such machine-learning tools operate by building a model from example training data in order to make data-driven predictions or decisions expressed as outputs or assessments. Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms use features for analyzing the data to generate an assessment. Each of the features is an individual measurable property of a phenomenon being observed. The concept of a feature is related to that of an explanatory variable used in statistical techniques such as linear regression. Choosing informative, discriminating, and independent features is important for the effective operation of the pattern recognition, classification, and regression. Features may be of different types, such as numeric features, strings, and graphs.

In one example, the features may be of different types and may include one or more of content, concepts, attributes, historical data, and/or user data, merely for example. The machine-learning algorithms use the training data to find correlations among the identified features that affect the outcome or assessment. In some examples, the training data includes labeled data, which is known data for one or more identified features and one or more outcomes, such as detecting communication patterns, detecting the meaning of the message, generating a summary of a message, detecting action items in messages detecting urgency in the message, detecting a relationship of the user to the sender, calculating score attributes, calculating message scores, detecting an error in an uncorrected gaze vector, etc.

With the training data and the identified features, the machine-learning tool is trained at machine-learning program training. The machine-learning tool appraises the value of the features as they correlate to the training data. The result of the training is the trained machine-learning program. When the trained machine-learning program is used to perform an assessment, new data is provided as an input to the trained machine-learning program, and the trained machine-learning program generates the assessment as output.

The machine-learning program supports two types of phases, namely a training phase and prediction phase. In training phases, supervised learning, unsupervised learning, or reinforcement learning may be used. For example, the machine-learning program (1) receives features (e.g., as structured or labeled data in supervised learning) and/or (2) identifies features (e.g., unstructured or unlabeled data for unsupervised learning) in training data. In prediction phases, the machine-learning program uses the features for analyzing query data to generate outcomes or predictions (as examples of an assessment).

In the training phase, feature engineering is used to identify features and may include identifying informative, discriminating, and independent features for the effective operation of the machine-learning program in pattern recognition, classification, and regression. In some examples, the training data includes labeled data, which is known data for pre-identified features and one or more outcomes. Each of the features may be a variable or attribute, such as individual measurable property of a process, article, system, or phenomenon represented by a data set (e.g., the training data).

In training phases, the machine-learning program uses the training data to find correlations among the features that affect a predicted outcome or assessment. With the training data and the identified features, the machine-learning program is trained during the training phase at machine-learning program training. The machine-learning program appraises values of the features as they correlate to the training data. The result of the training is the trained machine-learning program (e.g., a trained or learned model).

Further, the training phases may involve machine learning, in which the training data is structured (e.g., labeled during preprocessing operations), and the trained machine-learning program implements a relatively simple neural network capable of performing, for example, classification and clustering operations. In other examples, the training phase may involve deep learning, in which the training data is unstructured, and the trained machine-learning program implements a deep neural network that is able to perform both feature extraction and classification/clustering operations.

A neural network generated during the training phase, and implemented within the trained machine-learning program, may include a hierarchical (e.g., layered) organization of neurons. For example, neurons (or nodes) may be arranged hierarchically into a number of layers, including an input layer, an output layer, and multiple hidden layers. Each of the layers within the neural network can have one or many neurons, and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), a Generative Adversarial Network (GAN), and/or a Recursive Neural Network (RNN), merely for example.

During prediction phases, the trained machine-learning program is used to perform an assessment. Query data is provided as an input to the trained machine-learning program, and the trained machine-learning program generates the assessment as output, responsive to receipt of the query data.

For training the generative machine learning model to animate avatars speaking user speech, the training data includes pairs of audio files containing speech and corresponding video data showing synchronized lip movements and facial expressions. The model learns to identify key features in the speech audio, such as phonemes, timing, and emotional tone, and correlate these with appropriate avatar animations. During the training phase, the model processes structured training data that includes labeled pairs of speech audio and corresponding facial animations. Feature engineering focuses on extracting relevant characteristics from both the audio input (such as speech patterns, pauses, and tonal variations) and the animation output (such as lip positions, facial expressions, and temporal synchronization). The model learns to recognize patterns between speech features and appropriate avatar movements.

The neural network architecture implemented for avatar animation may include specialized components like Generative Adversarial Networks (GANs) that can generate realistic facial animations, and Recurrent Neural Networks (RNNs) that can process the temporal aspects of speech. The model learns to generate smooth, natural-looking animations that accurately reflect the timing and characteristics of the input speech. In the prediction phase, when processing new user speech input, the trained model analyzes the audio features and generates corresponding avatar animations in real-time. The model can handle various speech modifications, including language translation and emotional style changes, by learning correlations between different speech patterns and appropriate animation responses. This enables the system to generate realistic avatar animations without requiring complex tracking or modeling systems. The training process also incorporates techniques for handling different avatar types and customization options. The model learns to adapt the generated animations to different avatar facial structures while maintaining natural movement patterns. This allows the system to work effectively with avatars that have visual features representing the user or their friends, while ensuring consistent and realistic animation quality.

The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

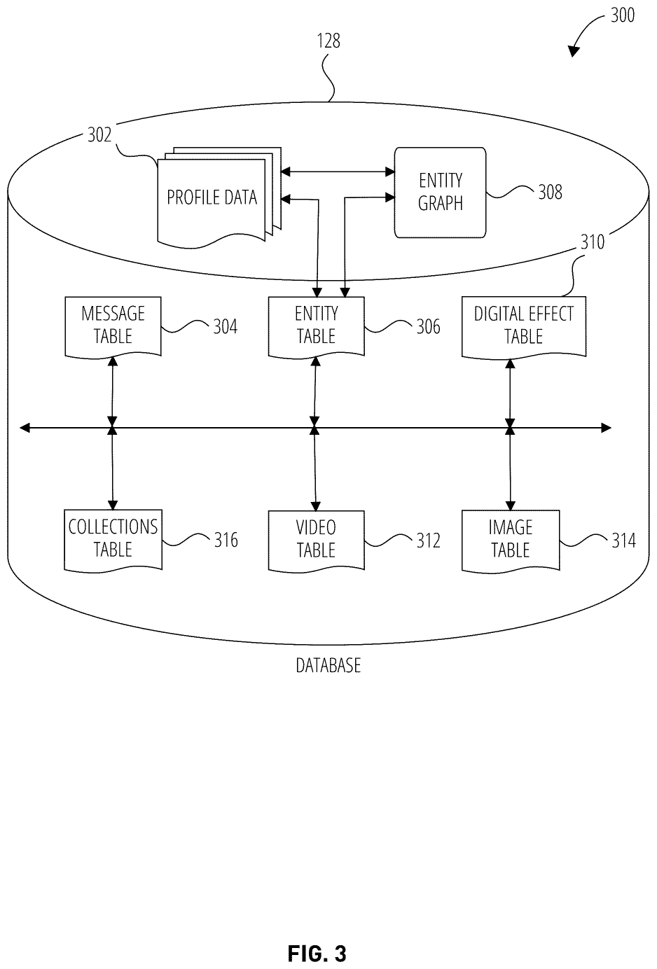

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data (e.g., instructions that define one or more digital effects experiences) that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 also include a list of digital effects experiences along with their respective sets of instructions (that define their operation) and/or code that is executed by tracking systems to provide outputs of the digital effects experiences.

In some examples, the database 128 stores comprehensive data to enable avatar speech animation functionality, discussed in detail below. The system maintains digital effects data in the digital effect table 310, including overlays, filters, and augmented reality content items. Useful to the avatar animation system are sets of instructions and textual prompts that the generative machine learning models process to create animations. For avatar-specific functionality, the database 128 stores avatar representations and collections in the profile data 302, including user-selected avatars with visual features that can represent users or their friends. The system maintains animation parameters and settings required for synchronizing lip movements with speech input.

The database 128 includes extensive audio and speech-related data, storing audio files captured by microphones in the message audio payload 410. The database 128 can maintain data about speech patterns, including predetermined patterns that may need removal like mumbling or pauses, as well as parameters for language translation and tone modification features.

### Data Communications Architecture

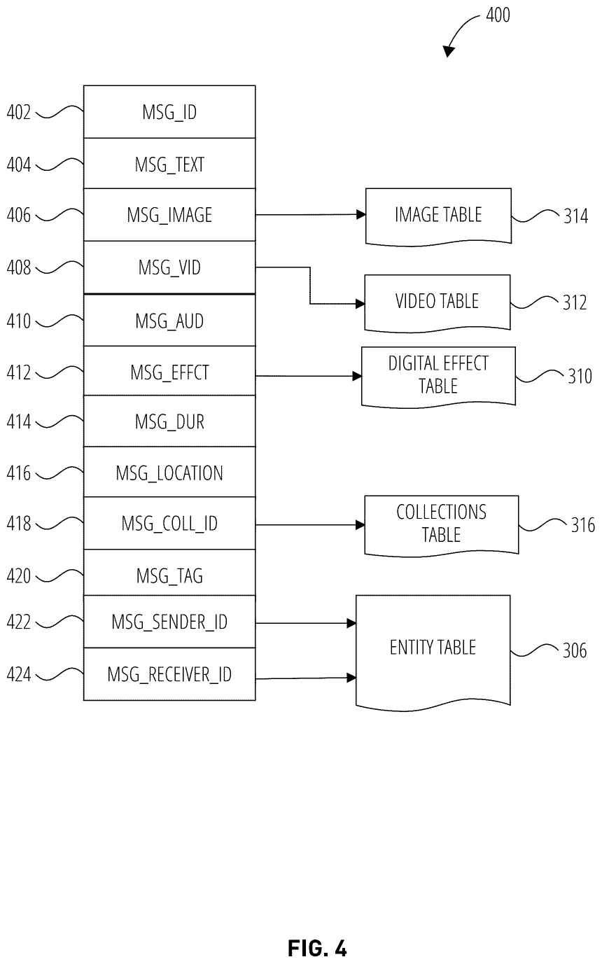

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

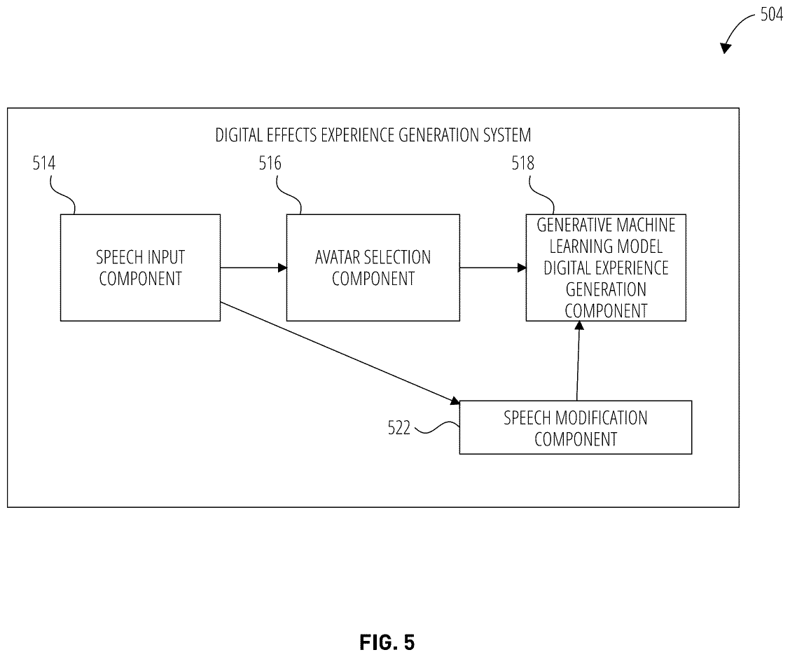

FIG. 5 illustrates a diagram of a digital effects experience generation system 504, according to some examples. The digital effects experience generation system 504 includes a speech input component 514, an avatar selection component 516, a generative machine learning model digital experience generation component 518, and a speech modification component 522.

Specifically, the speech input component 514 serves as the initial interface, capturing audio files containing user speech through the user system 102 microphone. This speech input component 514 also manages the presentation of available digital effects experiences through a digital experience selection interface (not shown), allowing users to select specific avatar animation options. The speech input component 514 can operate in conjunction with the speech modification component 522 to detect and filter predetermined speech patterns like mumbling or pauses before passing the processed audio to other components shown in FIG. 5.

In some examples, the speech input component 514 can access speech files through multiple sophisticated approaches that enable avatar animation generation. For example, the speech input component 514 can directly access speech through the microphone of the user system 102, capturing real-time audio as the user speaks. This captured audio is processed immediately and can be stored as an audio file in the message audio payload 410 that is provided to the generative machine learning model digital experience generation component 518 and/or speech modification component 522. The speech modification component 522 can detect and filter predetermined speech patterns during this direct capture process.

In some cases, the speech input component 514 can, when users capture video through the camera system 204, extract the audio file containing speech from the captured video. This approach is particularly useful when the video depicts the user speaking in a real-world environment, allowing the system to isolate and process the speech content separately from the video data. The speech input component 514 can access speech files stored within message audio payloads 410 from previously sent or received messages (in conversations with other users). This allows users to select existing speech content from their message history stored in the message table 304 for avatar animation purposes.

Through integration with the collection management system 220, the speech input component can access speech files stored within collections in the collections table 316. This enables users to select speech content that has been organized and curated into specific collections, such as event collections or personal collections. In some cases, the speech input component can work with the external resource system 226 to access speech files from connected applications or third-party servers 112. This includes accessing audio recordings stored in external applications or services that are integrated with the system through the Application Program Interface (API) server 122. The speech files can be imported and processed while maintaining their original quality and characteristics.

The avatar selection component 516 manages the selection and configuration of avatars, including those with visual features representing users or their friends. For example, the avatar selection component 516 can provide multiple approaches for selecting and configuring avatars that will be animated by the generative machine learning model digital experience generation component 518. In some cases, user profile avatar selection can enable users to access their existing avatar representations stored in the profile data 302. When a user selects their profile avatar, the avatar selection component 516 retrieves the stored visual features and customizations that represent the user's appearance. These avatars can include specific characteristics like facial features, clothing, and expressions that make the avatar personally identifiable as the user. The retrieved avatar can then be provided as one of the inputs to the generative machine learning model digital experience generation component 518.

In some cases, a friend-based avatar selection leverages the entity relationships stored in the entity graph 308 to allow users to animate avatars representing their friends. The avatar selection component 516 can access friend relationships and associated avatar data through the entity table 306, enabling users to select and animate avatars that maintain the visual characteristics of their friends. This functionality supports social interactions and group communications by allowing users to create animations using recognizable representations of their social connections. The retrieved friend avatar can then be provided as one of the inputs to the generative machine learning model digital experience generation component 518. A multi-avatar group selection can extend the animation capabilities by enabling simultaneous selection of multiple friend avatars. When processing group selections, the generative machine learning model can create synchronized animations showing multiple avatars speaking in harmony while maintaining individual personality traits and expressions. This feature is particularly useful for creating group messages or social media content that includes multiple animated participants. Each avatar can be represented as speaking different parts of the same speech file provided by the speech input component 514, speaking the same parts of the same speech file in harmony, or speaking different respective speech components of different speech files accessed by the speech input component 514.

Bitmoji integration allows users to import and select their existing 3D Bitmoji models for animation. The avatar selection component 516 can access these models from connected applications or user profiles, maintaining the personalized features and customizations already established by the user. The generative machine learning model processes these bitmoji models to create animations that preserve the distinctive characteristics of the user's customized avatar. A collection-based selection organizes avatars into themed or categorical collections stored in the collections table 316. Users can browse and select from these collections based on specific contexts or preferences. The avatar selection component 516 can maintain relationships between collections and their associated avatars, enabling efficient organization and retrieval of avatar options suitable for different animation scenarios. Status avatar selection provides specialized avatar representations designed to communicate particular statuses or activities. These avatars include specific visual elements that convey status information, and when animated, the generative machine learning model can incorporate these status-specific characteristics into the generated animations.

An environment-specific selection offers avatars optimized for particular digital effects experiences, such as in AR/VR environments. These avatars are designed with features and characteristics that enhance their appearance and performance within specific digital contexts. The generative machine learning model can process these specialized avatars to create animations that integrate seamlessly with the target environment. In some cases, a dynamic avatar selection enables real-time modifications to selected avatars during the animation process by the avatar selection component 516. Users can select avatars that support dynamic updates, allowing the generative machine learning model to adjust the animation based on ongoing user interactions, speech modifications, or changes in emotional expression. This capability ensures that the animated avatars remain responsive and adaptable throughout the digital effects experience.

In some examples, the generative machine learning model digital experience generation component 518 processes textual prompts along with the audio input received from the speech input component 514 and selected avatar received from the avatar selection component 516 to generate animations. For example, the generative machine learning model digital experience generation component 518 can first receive an English speech audio through the speech input component 514 and process the English speech audio to identify speech patterns and characteristics. The generative machine learning model digital experience generation component 518 can then access the selected avatar data and target language parameters (which may be received via user input that selects one or more languages). The generative machine learning model digital experience generation component 518 processes these inputs along with a prompt instructing translation to Japanese while preserving natural speaking patterns. The generative machine learning model digital experience generation component 518 generates an initial audio translation, then creates synchronized lip movements and facial expressions for the selected avatar that match Japanese cultural speaking mannerisms. The final video output shows the avatar (selected by the avatar selection component 516) speaking the translated content with appropriate expressions, which can be overlaid on educational materials (or other video content items) through the digital effect system 206.

In emotional style transformation, the generative machine learning model digital experience generation component 518 can analyze the neutral speech input to identify baseline speech characteristics. The avatar selection component 516 provides the selected avatar data, while a prompt specifies the transformation to a humorous emotional style. The generative machine learning model digital experience generation component 518 processes these elements to modify speech patterns and generate corresponding exaggerated facial expressions and gestures. The generative machine learning model digital experience generation component 518 can maintain speech clarity while adding comedic timing elements. The resulting animation incorporates these modifications while preserving the avatar's core visual features, creating content suitable for social media integration.

For multi-language simultaneous animation, the generative machine learning model digital experience generation component 518 can process the original speech input from the speech input component 514 multiple times, generating translations for each selected language (each language that has been selected by a user on the user system 102 from a list presented to a user on a graphical user interface of the user system 102). The generative machine learning model digital experience generation component 518 creates parallel processing streams for English, Spanish, and Mandarin versions, each maintaining culturally appropriate expressions and speaking patterns. The generative machine learning model digital experience generation component 518 then synchronizes these separate animations and combines them into a split-screen format. The final output preserves timing alignment across all language versions while maintaining distinct cultural characteristics for each animation stream.

In speech pattern enhancement, the generative machine learning model digital experience generation component 518 can first analyze the input audio to identify pauses, mumbling, and unclear speech patterns. The generative machine learning model digital experience generation component 518 processes the cleaned speech data along with the avatar selection, applying professional speaking patterns and formal mannerisms. The generative machine learning model digital experience generation component 518 can generate smooth transitions between speech segments and creates corresponding facial animations that convey professionalism. The resulting animation displays refined speech patterns with appropriate business-oriented expressions and demeanor. In some cases, the generative machine learning model digital experience generation component 518 first analyzes the input audio to identify pauses, mumbling, and unclear speech patterns, including words that appear on an exclusion list. When the speech modification component 522 detects these patterns and removes them from the audio file and replaces them with silence having a duration corresponding to the removed speech segments.

The generative machine learning model digital experience generation component 518 then processes this modified speech data along with the avatar selection, applying professional speaking patterns and formal mannerisms. During this processing, the generative machine learning model digital experience generation component 518 maintains appropriate timing by preserving the inserted silence segments, allowing the avatar's facial animations to reflect natural pauses in speech. The generative machine learning model digital experience generation component 518 generates smooth transitions between speech segments, creating corresponding facial animations that appropriately represent these pauses while conveying professionalism. The resulting animation displays refined speech patterns with appropriate business-oriented expressions and demeanor, where the avatar's lip movements and facial expressions naturally pause during the silence segments that replaced the removed speech patterns. This maintains the natural flow and timing of the speech while ensuring inappropriate content or unclear speech is professionally handled.

In some cases, the generative machine learning model digital experience generation component 518 can first analyze the input audio to identify pauses, mumbling, and unclear speech patterns, including words that appear on an exclusion list. When the speech modification component 522 detects these patterns, the speech modification component 522 can generate replacement content to fill the gaps rather than simply inserting silence. The speech modification component 522 processes the surrounding speech context to generate appropriate replacement words or phrases that maintain professional tone and clarity. The generative machine learning model digital experience generation component 518 then processes this enhanced speech data along with the avatar selection, applying professional speaking patterns and formal mannerisms. During this processing, the system generates new speech segments to replace the removed content, ensuring continuous flow while maintaining appropriate professional language and tone. The generative machine learning model digital experience generation component 518 analyzes the context before and after each replaced segment to ensure the generated content fits naturally within the overall speech pattern.

The generative machine learning model digital experience generation component 518 then creates corresponding facial animations that smoothly transition through the newly generated speech segments. The generative machine learning model digital experience generation component 518 ensures the avatar's lip movements and expressions align precisely with both the original and replacement speech content. This creates a seamless integration where the avatar's animations reflect natural speaking patterns while maintaining professional demeanor throughout both original and generated content. The resulting animation displays refined speech patterns with appropriate business-oriented expressions and demeanor, where the avatar's lip movements and facial expressions flow naturally through both original and replacement content. This approach maintains professional communication standards while ensuring continuous, uninterrupted speech flow. The final output presents a polished, professional delivery that seamlessly integrates generated content to replace any detected inappropriate or unclear speech patterns.

For friend group animation, the generative machine learning model digital experience generation component 518 can process the single speech input along with multiple avatar selections accessed through the entity graph 308. The generative machine learning model digital experience generation component 518 can create distinct personality traits for each avatar while maintaining speech synchronization. The generative machine learning model digital experience generation component 518 processes each avatar's unique characteristics to generate individualized expressions and gestures that align with their personality traits. The final output shows all avatars speaking in harmony while displaying their unique characteristics, suitable for group messaging contexts.

The generative machine learning model digital experience generation component 518 can continuously process real-time inputs while presenting these animations, allowing for dynamic updates to the avatar's movements and expressions based on changes in speech or user interactions. The generated animations can be integrated into various digital effects experiences, including AR/VR environments, and can be overlaid on existing content or used to replace real video footage of users speaking.

In some examples, when a user captures video through the camera system 204 showing themselves talking about a real-world scene, the speech input component 514 can receive the video and extract the audio file containing their speech from the captured video while preserving the original speech patterns and content that will drive the avatar animation. The avatar selection component 516 enables the user to select an avatar to replace their appearance, either using their existing profile avatar with customized visual features or choosing from other available avatar options stored in their profile data 302. The generative machine learning model digital experience generation component 518 then processes both the extracted speech audio and selected avatar to generate an animation with synchronized lip movements matching the original speech. The generative machine learning model digital experience generation component 518 can ensure the avatar's facial expressions and gestures align naturally with the speaking patterns while maintaining fluid movement. For scene integration, the digital effects experience generation system 504 can either overlay the animated avatar directly over the user's appearance in the original video to maintain the same real-world background and context, or the digital effects experience generation system 504 can process a prompt to generate an entirely new scene while preserving the speech content.

For example, if the original video shows the user discussing a beach location, the digital effects experience generation system 504 could process a prompt specifying: “Generate animation of selected avatar speaking the provided audio within a 3D rendered beach environment, maintaining natural environmental lighting and appropriate background elements.” The digital effects experience generation system 504 handles the integration of the generated avatar animation with either the original or newly generated scene, continuously processing inputs during playback to maintain proper synchronization between the avatar's movements, speech, and environmental elements.

This functionality enables various applications, including educational content where users want to explain concepts about locations without appearing on camera, social media posts where avatar representation is preferred over personal appearance, and professional presentations requiring polished avatar delivery. The digital effects experience generation system 504 maintains the natural flow and timing of the original speech while allowing users to choose how their visual presence is represented in the final content.

In some examples, when processing tone and style modifications, the generative machine learning model digital experience generation component 518 can first analyze the input speech to determine its initial tone or style characteristics. For example, the generative machine learning model digital experience generation component 518 processes an initial prompt like: “Analyze input speech to identify emotional characteristics, speaking pace, and delivery style to establish baseline tone classification.” The generative machine learning model digital experience generation component 518 then processes the audio file using specific transformation prompts. For instance, the generative machine learning model digital experience generation component 518 might process prompts such as: “Transform neutral business presentation into an engaging, enthusiastic delivery while maintaining professional vocabulary” or “Convert serious technical explanation into a casual, friendly tone with appropriate colloquial language substitutions.” During this processing, the generative machine learning model digital experience generation component 518 can add, replace, or remove certain words from the original speech to achieve the desired emotional style transformation.

The generative machine learning model digital experience generation component 518 can then apply the newly generated audio file with the selected avatar using detailed animation prompts such as: “Generate avatar animation with exaggerated facial expressions and gestures matching humorous speech patterns” and “Create fluid transitions between emotional states as speech tone shifts from serious to playful.” The generative machine learning model digital experience generation component 518 ensures the avatar's facial expressions, gestures, and lip movements align precisely with the new speaking style while maintaining natural movement and speech synchronization.

The resulting output generated by the generative machine learning model digital experience generation component 518 shows the avatar speaking with appropriate facial expressions and body language matching the second tone or style. The generative machine learning model digital experience generation component 518 can process additional refinement prompts like: “Enhance comedic timing by adjusting pause durations between phrases” and “Add subtle head movements and eyebrow raises to emphasize key emotional moments.” This enables users to repurpose their speech content with different emotional deliveries while maintaining the core message and speech clarity, with the generative machine learning model digital experience generation component 518 processing prompts to modify specific words and phrases to achieve the desired style transformation.

In some examples, when implementing brand messaging consistency, the speech input component 514 first analyzes a collection of existing corporate videos to establish the company's baseline speaking style and tone characteristics. The digital effects experience generation system 504 processes these videos through the generative machine learning model digital experience generation component 518 using prompts such as: “Analyze corporate video collection to identify consistent speaking patterns, professional vocabulary usage, and brand-specific delivery characteristics.”

The generative machine learning model digital experience generation component 518 can then process this analysis to create a style profile that captures the company's distinctive communication patterns. When new speech input is received, the speech modification component 522 evaluates the new speech input against this established style profile. The digital effects experience generation system 504 can then generate prompts to transform the input speech to align with the corporate style, such as: “Transform input speech to match established corporate tone while maintaining professional pacing and vocabulary consistent with analyzed brand communications.”

The avatar selection component 516 works with the established brand identity to select or customize an avatar that represents the company's visual standards. The generative machine learning model digital experience generation component 518 then processes both the style-aligned speech and brand-appropriate avatar using specific animation prompts like: “Generate avatar animation with professional gestures and expressions matching corporate speaking style” and “Maintain consistent brand personality through facial expressions and body language.” The digital effect system 206 integrates the generated avatar animation with appropriate corporate backgrounds or content, as shown in the user interface 604. The generative machine learning model digital experience generation component 518 continuously processes inputs during playback to ensure the avatar's movements and expressions maintain brand consistency while delivering the transformed speech content. This creates a unified brand presentation where all elements-speech patterns, avatar appearance, and delivery style-align with the company's established communication standards.

These examples demonstrate the versatility of the generative machine learning model digital experience generation component 518, highlighting its ability to process various inputs, generate diverse digital effects, and respond to different conditions in real-time, all without relying on traditional SLAM or 3D modeling techniques.

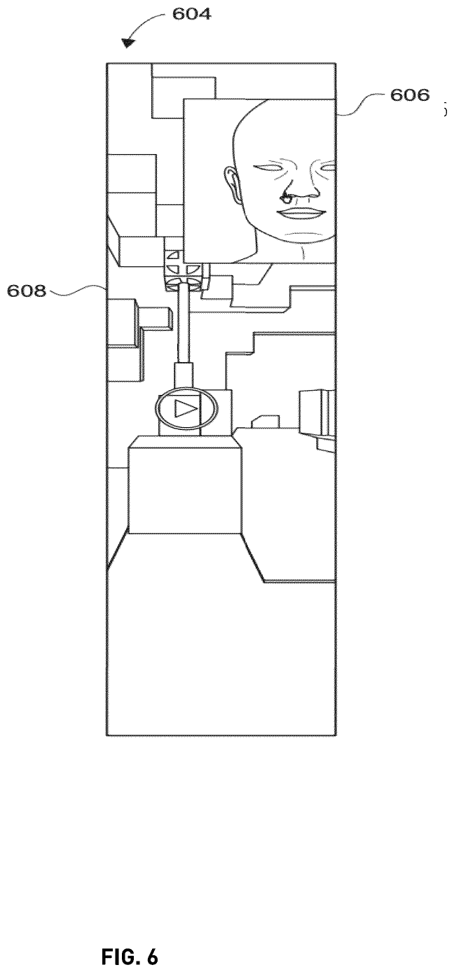

FIG. 6 illustrates an example output of the digital effects experience generation system 504, according to some examples. Specifically, the visual output shown in the user interface 604 of FIG. 6 demonstrates how the animations generated by the digital effects experience generation system 504 can be presented on the user system 102.

For example, when implementing speech pattern enhancement, the generative machine learning model digital experience generation component 518 first processes the user's speech to generate an enhanced avatar animation. The generative machine learning model digital experience generation component 518 can analyze the input audio to identify speech patterns and generate corresponding facial animations with professional speaking patterns and formal mannerisms. This animated avatar content is then overlaid as the avatar 606 (or video of the avatar animation) on the content item 608, shown in the user interface 604.

The digital effect system 206 handles the integration of the generated avatar animation with the underlying content item 608, continuously processing inputs during playback to maintain proper synchronization. The digital effect system 206 ensures the avatar's movements and expressions remain properly integrated with the background content while preserving natural speech flow and professional demeanor. This overlay capability enables various applications, such as educational content where users want to explain concepts without appearing on camera themselves. The user interface 604 shows how the avatar animation (e.g., avatar 606) can be seamlessly integrated with existing an existing content item 608 while maintaining professional presentation quality. The interface allows users to view both the animated avatar and the underlying content simultaneously, creating an engaging viewing experience that combines the avatar's speech delivery with relevant visual context.

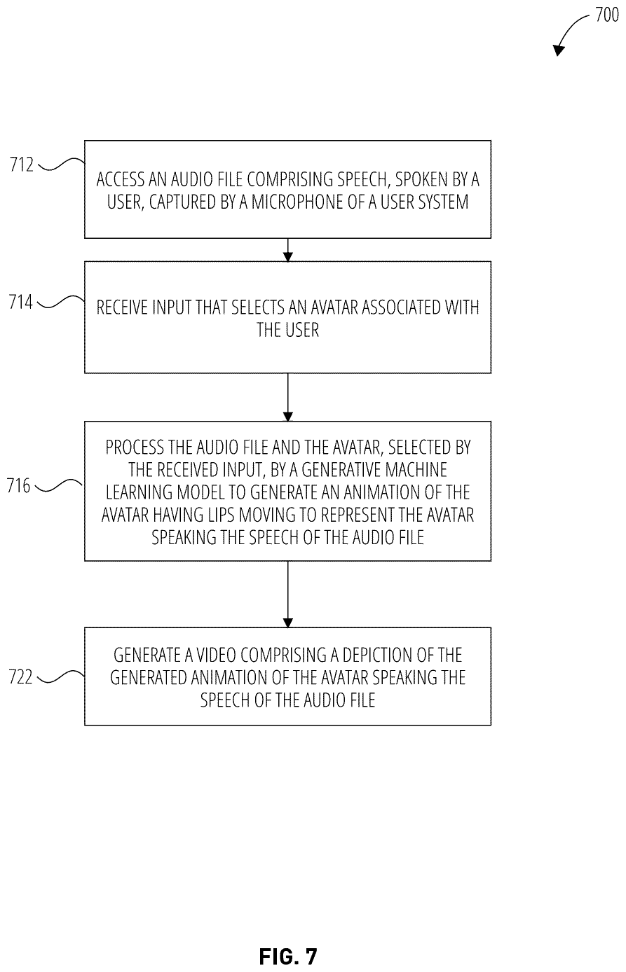

FIG. 7 is a flowchart illustrating routine 700 (e.g., a method or process), according to some examples. Although the example method depicted in FIG. 7 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 712, the digital effects experience generation system 504 accesses an audio file containing speech captured by a microphone of a user system 102 and receives input selecting an avatar associated with the user, as discussed above. This initial operation enables the system to obtain the necessary inputs for generating the avatar animation.

In operation 714, the digital effects experience generation system 504 receives input that selects an avatar associated with the user.

In operation 716, the digital effects experience generation system 504 processes the audio file and selected avatar using a generative machine learning model, as discussed above. The model analyzes the speech patterns and generates an animation showing the avatar's lips moving in synchronization with the speech. This operation can include additional processing such as removing predetermined speech patterns, translating languages, or modifying speech tone and style. The digital effects experience generation system 504 continuously processes inputs received while presenting the avatar animation. These inputs can include additional speech, user interactions, or environmental data captured by the user system 102. The generative machine learning model processes these inputs in real-time along with the original instructions to update the avatar animation, ensuring the lip movements remain synchronized with any changes in speech or other modifications.

In operation 722, the system generates a video containing a depiction of the generated animation of the avatar speaking the speech from the audio file, as discussed above. This final operation produces the output that can be integrated into digital effects experiences or overlaid on other content.

### System with Head-Wearable Apparatus

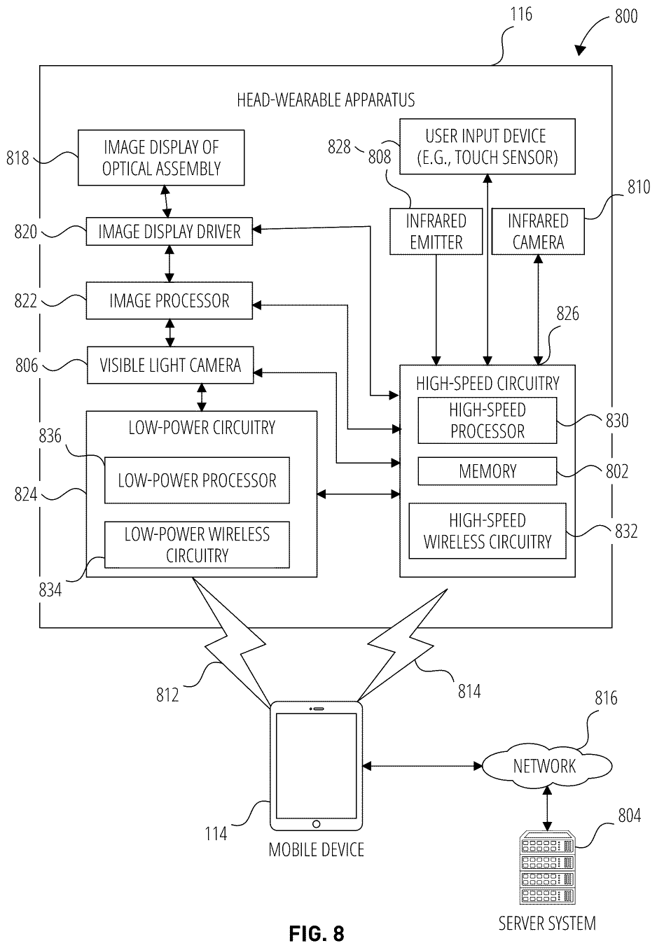

FIG. 8 illustrates a system 800 including a head-wearable apparatus 116 with a selector input device, according to some examples. FIG. 8 is a high-level functional block diagram of an example head-wearable apparatus 116 communicatively coupled to a mobile device 114 and various server systems 804 (e.g., the server system 110) via various networks.

The head-wearable apparatus 116 includes one or more cameras, each of which may be, for example, a visible light camera 806, an infrared emitter 808, and an infrared camera 810.

The mobile device 114 connects with head-wearable apparatus 116 using both a low-power wireless connection 812 and a high-speed wireless connection 814. The mobile device 114 is also connected to the server system 804 and the Network 816.

The head-wearable apparatus 116 further includes two image displays of the image display of optical assembly 818. The two image displays of optical assembly 818 include one associated with the left lateral side and one associated with the right lateral side of the head-wearable apparatus 116. The head-wearable apparatus 116 also includes an image display driver 820, an image processor 822, low-power circuitry 824, and high-speed circuitry 826. The image display of optical assembly 818 is for presenting images and videos, including an image that can include a graphical user interface to a user of the head-wearable apparatus 116.

The image display driver 820 commands and controls the image display of optical assembly 818. The image display driver 820 may deliver image data directly to the image display of optical assembly 818 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 828 (e.g., touch sensor or push button), including an input surface on the head-wearable apparatus 116. The user input device 828 (e.g., touch sensor or push button) is to receive from the user an input selection to manipulate the graphical user interface of the presented image.

The components shown in FIG. 8 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 806 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 802, which stores instructions to perform a subset, or all the functions described herein. The memory 802 can also include storage device.

As shown in FIG. 8, the high-speed circuitry 826 includes a high-speed processor 830, a memory 802, and high-speed wireless circuitry 832. In some examples, the image display driver 820 is coupled to the high-speed circuitry 826 and operated by the high-speed processor 830 to drive the left and right image displays of the image display of optical assembly 818. The high-speed processor 830 may be any processor capable of managing high-speed communications and operation of any general computing system needed for the head-wearable apparatus 116. The high-speed processor 830 includes processing resources needed for managing high-speed data transfers on a high-speed wireless connection 814 to a wireless local area network (WLAN) using the high-speed wireless circuitry 832. In certain examples, the high-speed processor 830 executes an operating system such as a LINUX operating system or other such operating system of the head-wearable apparatus 116, and the operating system is stored in the memory 802 for execution. In addition to any other responsibilities, the high-speed processor 830 executing a software architecture for the head-wearable apparatus 116 is used to manage data transfers with high-speed wireless circuitry 832. In certain examples, the high-speed wireless circuitry 832 is configured to implement Institute of Electrical and Electronic Engineers (IEEE) 802.11 communication standards, also referred to herein as WI-FI®. In some examples, other high-speed communications standards may be implemented by the high-speed wireless circuitry 832.

The low-power wireless circuitry 834 and the high-speed wireless circuitry 832 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 812 and the high-speed wireless connection 814, may be implemented using details of the architecture of the head-wearable apparatus 116, as can other elements of the Network 816.

The memory 802 includes any storage device capable of storing various data and applications, including, among other things, camera data generated by the left and right visible light cameras 806, the infrared camera 810, and the image processor 822, as well as images generated for display by the image display driver 820 on the image displays of the image display of optical assembly 818. While the memory 802 is shown as integrated with high-speed circuitry 826, in some examples, the memory 802 may be an independent standalone element of the head-wearable apparatus 116. In certain such examples, electrical routing lines may provide a connection through a chip that includes the high-speed processor 830 from the image processor 822 or the low-power processor 836 to the memory 802. In some examples, the high-speed processor 830 may manage addressing of the memory 802 such that the low-power processor 936 will boot the high-speed processor 830 any time that a read or write operation involving memory 802 is needed.

As shown in FIG. 8, the low-power processor 836 or high-speed processor 830 of the head-wearable apparatus 116 can be coupled to the camera (visible light camera 806, infrared emitter 808, or infrared camera 810), the image display driver 820, the user input device 828 (e.g., touch sensor or push button), and the memory 802.

The head-wearable apparatus 116 is connected to a host computer. For example, the head-wearable apparatus 116 is paired with the mobile device 114 via the high-speed wireless connection 814 or connected to the server system 804 via the Network 816. The server system 804 may be one or more computing devices as part of a service or network computing system, for example, that includes a processor, a memory, and network communication interface to communicate over the Network 816 with the mobile device 114 and the head-wearable apparatus 116.

The mobile device 114 includes a processor and a network communication interface coupled to the processor. The Network communication interface allows for communication over the Network 816, low-power wireless connection 812, or high-speed wireless connection 814. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 820. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 804, such as the user input device 828, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any input/output (I/O) components including output components, motion components, position components, or any other such elements described herein.

In some examples, the head-wearable apparatus 116 may include biometric components or sensors s to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 812 and high-speed wireless connection 814 from the mobile device 114 via the low-power wireless circuitry 834 or high-speed wireless circuitry 832.

### Machine Architecture

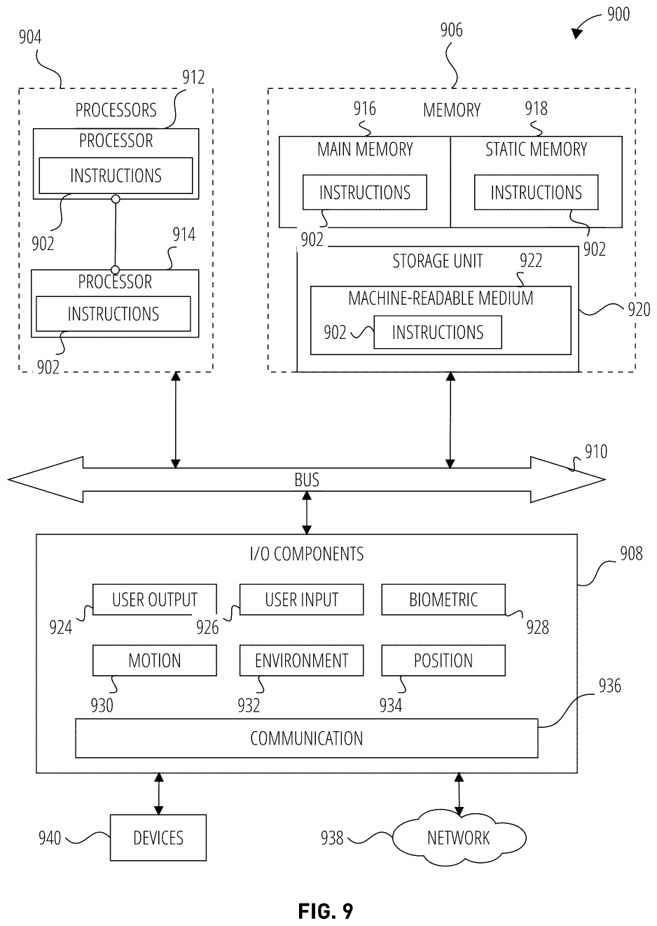

FIG. 9 is a diagrammatic representation of the machine 900 within which instructions 902 (e.g., software, a program, an application, an applet, an app, or other executable code) for causing the machine 900 to perform any one or more of the methodologies discussed herein may be executed. For example, the instructions 902 may cause the machine 900 to execute any one or more of the methods described herein. The instructions 902 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 902, sequentially or otherwise, that specify actions to be taken by the machine 900. Further, while a single machine 900 is illustrated, the term “machine” shall also be taken to include a collection of machines that individually or jointly execute the instructions 902 to perform any one or more of the methodologies discussed herein. The machine 900, for example, may comprise the user system 102 or any one of multiple server devices forming part of the server system 110. In some examples, the machine 900 may also comprise both client and server systems, with certain operations of a particular method or algorithm being performed on the server-side and with certain operations of the method or algorithm being performed on the client-side.

The machine 900 may include processors 904, memory 906, and input/output I/O components 908, which may be configured to communicate with each other via a bus 910.

The memory 906 includes a main memory 916, a static memory 918, and a storage unit 920, both accessible to the processors 904 (e.g., processor 912 or processor 914 via the bus 910. The main memory 906, the static memory 918, and storage unit 920 store the instructions 902 embodying any one or more of the methodologies or functions described herein. The instructions 902 may also reside, completely or partially, within the main memory 916, within the static memory 918, within machine-readable medium 922 within the storage unit 920, within at least one of the Processors 904 (e.g., within the processor's cache memory), or any suitable combination thereof, during execution thereof by the machine 900.

The I/O components 908 may include a wide variety of components to receive input, provide output, produce output, transmit information, exchange information, capture measurements, and so on. The specific I/O components 908 that are included in a particular machine will depend on the type of machine. For example, portable machines such as mobile phones may include a touch input device or other such input mechanisms, while a headless server machine will likely not include such a touch input device. It will be appreciated that the I/O components 908 may include many other components that are not shown in FIG. 9. In various examples, the I/O components 908 may include user output components 924 and user input components 926. The user output components 924 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 926 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 908 may include biometric components 928, motion components 930, environmental components 932, or position components 934, among a wide array of other components. For example, the biometric components 928 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 930 include acceleration sensor components (e.g., accelerometer), gravitation sensor components, rotation sensor components (e.g., gyroscope).

The environmental components 932 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 908 further include communication components 936 operable to couple the machine 900 to a Network 938 or devices 940 via respective coupling or connections. For example, the communication components 936 may include a network interface component or another suitable device to interface with the Network 938. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 940 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, DataglyphTM, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (e.g., main memory 916, static memory 918, and memory of the Processors 904) and storage unit 920 may store one or more sets of instructions and data structures (e.g., software) embodying or used by any one or more of the methodologies or functions described herein. These instructions (e.g., the instructions 902), when executed by Processors 904, cause various operations to implement the disclosed examples.

The instructions 902 may be transmitted or received over the Network 938, using a transmission medium, via a network interface device (e.g., a network interface component included in the communication components 936) and using any one of several well-known transfer protocols (e.g., hypertext transfer protocol (HTTP)). Similarly, the instructions 902 may be transmitted or received using a transmission medium via a coupling (e.g., a peer-to-peer coupling) to the devices 940.

### Software Architecture

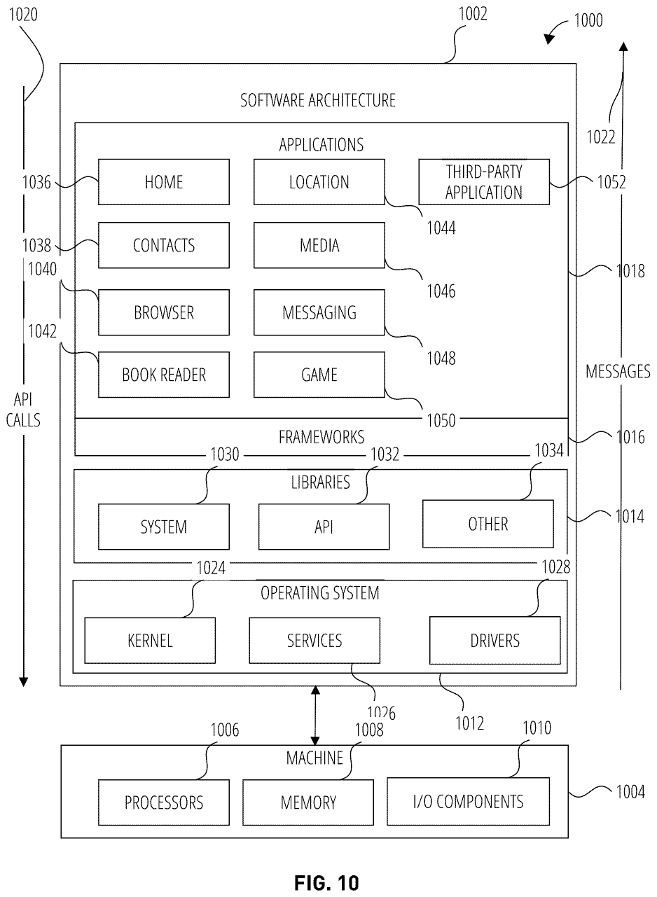

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematical functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various graphical user interface (GUI) functions, high-level resource management, and high-level location services. The frameworks 1016 can provide a broad spectrum of other APIs that can be used by the applications 1018, some of which may be specific to a particular operating system or platform.

In an example, the applications 1018 may include a home application 1036, a contacts application 1038, a browser application 1040, a book reader application 1042, a location application 1044, a media application 1046, a messaging application 1048, a game application 1050, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1. A system comprising: at least one processor; at least one memory component storing instructions that, when executed by the at least one processor, cause the at least one processor to perform operations comprising: accessing an audio file comprising speech, spoken by a user, captured by a microphone of a user system; receiving input that selects an avatar associated with the user; processing the audio file and the avatar, selected by the received input, by a generative machine learning model to generate an animation of the avatar having lips moving to represent the avatar speaking the speech of the audio file; and generating a video comprising a depiction of the generated animation of the avatar speaking the speech of the audio file.

Example 2. The system of Example 1, wherein the operations comprise: adding the video comprising the depiction of the generated animation of the avatar speaking the speech of the audio file to a digital effects experience.

Example 3. The system of Example 2, wherein the digital effects experience comprises an augmented reality (AR) or virtual reality (VR) experience.

Example 4. The system of any one of Examples 2-3, wherein the digital effects experience comprises a content item over which the video is overlaid.

Example 5. The system of any one of Examples 1-4, wherein the operations comprise: accessing a video captured by a camera of the user system, the video depicting a real-world environment, the video being captured concurrently with capturing the speech spoken by the user; and extracting, from the video captured by the camera, the audio file comprising the speech spoken by the user.

Example 6. The system of Example 5, wherein the operations comprise: overlaying the video comprising the depiction of the generated animation of the avatar speaking the speech of the audio file on the video that depicts the real-world environment.

Example 7. The system of Example 6, wherein the video depicts the user speaking the speech, wherein the operations comprise: replacing a depiction of the user with the animation of the avatar.

Example 8. The system of any one of Examples 1-7, wherein the operations comprise: presenting a list of different avatars; and selecting one of the avatars from the list in response to receiving the input.

Example 9. The system of any one of Examples 1-8, wherein the operations comprise: detecting a set of predetermined patterns of speech in the audio file; and removing the set of predetermined patterns of speech from the audio file prior to processing the audio file by the generative machine learning model.

Example 10. The system of Example 9, wherein the set of predetermined patterns of speech comprise at least one of mumbling, one or more words on an exclusion list, or pauses.

Example 11. The system of any one of Examples 9-10, wherein the operations comprise: replacing the set of predetermined patterns of speech with silence having a duration corresponding to the set of predetermined patterns of speech that have been removed.

Example 12. The system of any one of Examples 1-11, wherein the operations comprise: determining that the speech in the audio file is spoken in a first language; processing the audio file by the generative machine learning model based on a prompt with an instruction to generate a new audio file with the speech spoken in a second language; and applying the new audio file with the avatar to the generative machine learning model, wherein the animation of the avatar represents the avatar speaking the speech in the second language.

Example 13. The system of Example 12, wherein the operations comprise: providing an additional prompt to the generative machine learning model with instructions to generate the animation of the avatar speaking the speech from the new audio file.

Example 14. The system of any one of Examples 12-13, wherein the operations comprise: receiving additional input that selects one or more additional languages comprising the second language; and in response to determining that a plurality of different languages have been selected by the additional input, causing the generative machine learning model to simultaneously generate multiple animations of the avatar, each of the multiple animations representing the avatar speaking the speech in a respective language of the different languages selected by the additional input.

Example 15. The system of any one of Examples 1-14, wherein the operations comprise: determining that the speech in the audio file is spoken in a first tone or first style; processing the audio file by the generative machine learning model based on a prompt with an instruction to generate a new audio file with the speech spoken in a second tone or second style; and applying the new audio file with the avatar to the generative machine learning model, wherein the animation of the avatar represents the avatar speaking the speech in the second tone or second style.

Example 16. The system of Example 15, wherein the second tone or second style is associated with a humorous emotion different from an emotion of the first tone or first style.

Example 17. The system of any one of Examples 15-16, wherein processing the audio file to generate the new audio file comprises adding, replacing, or removing one or more words spoken in the audio file to cause the speech to be spoken in the second tone or second style.

Example 18. The system of any one of Examples 1-17, wherein the avatar has visual features representing the user or a friend of the user.

Example 19. A computer-implemented method comprising: accessing, by one or more processors, an audio file comprising speech, spoken by a user, captured by a microphone of a user system; receiving input that selects an avatar associated with the user; processing the audio file and the avatar, selected by the received input, by a generative machine learning model to generate an animation of the avatar having lips moving to represent the avatar speaking the speech of the audio file; and generating a video comprising a depiction of the generated animation of the avatar speaking the speech of the audio file.

Example 20. A non-transitory computer-readable storage medium storing instructions that, when executed by at least one processor, cause the at least one processor to perform operations comprising: accessing an audio file comprising speech, spoken by a user, captured by a microphone of a user system; receiving input that selects an avatar associated with the user; processing the audio file and the avatar, selected by the received input, by a generative machine learning model to generate an animation of the avatar having lips moving to represent the avatar speaking the speech of the audio file; and generating a video comprising a depiction of the generated animation of the avatar speaking the speech of the audio file.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time.

For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein.

As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” and “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
accessing an audio file comprising speech, spoken by a user, captured by a microphone of a user system;
receiving input that selects an avatar associated with the user;
processing the audio file and the avatar, selected by the received input, by a generative machine learning model to generate an animation of the avatar having lips moving to represent the avatar speaking the speech of the audio file; and
generating a video comprising a depiction of the generated animation of the avatar speaking the speech of the audio file, the video being selectable for insertion into one or more content items.

2. The system of claim 1, wherein the operations comprise:
adding the video comprising the depiction of the generated animation of the avatar speaking the speech of the audio file to a digital effects experience.

3. The system of claim 2, wherein the digital effects experience comprises an augmented reality (AR) or virtual reality (VR) experience.

4. The system of claim 2, wherein the digital effects experience comprises a content item over which the video is overlaid.

5. The system of claim 1, wherein the operations comprise:
accessing a video captured by a camera of the user system, the video depicting a real-world environment, the video being captured concurrently with capturing the speech spoken by the user; and
extracting, from the video captured by the camera, the audio file comprising the speech spoken by the user.

6. The system of claim 5, wherein the operations comprise:
overlaying the video comprising the depiction of the generated animation of the avatar speaking the speech of the audio file on the video that depicts the real-world environment.

7. The system of claim 6, wherein the video depicts the user speaking the speech, wherein the operations comprise:
replacing a depiction of the user with the animation of the avatar.

8. The system of claim 1, wherein the operations comprise:
presenting a list of different avatars; and
selecting one of the avatars from the list in response to receiving the input.

9. The system of claim 1, wherein the operations comprise:
detecting a set of predetermined patterns of speech in the audio file; and
removing the set of predetermined patterns of speech from the audio file prior to processing the audio file by the generative machine learning model.

10. The system of claim 9, wherein the set of predetermined patterns of speech comprise at least one of mumbling, one or more words on an exclusion list, or pauses.

11. The system of claim 9, wherein the operations comprise:
replacing the set of predetermined patterns of speech with silence having a duration corresponding to the set of predetermined patterns of speech that have been removed.

12. The system of claim 1, wherein the operations comprise:
determining that the speech in the audio file is spoken in a first language;
processing the audio file by the generative machine learning model based on a prompt with an instruction to generate a new audio file with the speech spoken in a second language; and
applying the generative machine learning model to the new audio file with the avatar, wherein the animation of the avatar represents the avatar speaking the speech in the second language.

13. The system of claim 12, wherein the operations comprise:
providing an additional prompt to the generative machine learning model with instructions to generate the animation of the avatar speaking the speech from the new audio file.

14. The system of claim 12, wherein the operations comprise:
receiving additional input that selects one or more additional languages comprising the second language; and
in response to determining that a plurality of different languages have been selected by the additional input, causing the generative machine learning model to simultaneously generate multiple animations of the avatar, each of the multiple animations representing the avatar speaking the speech in a respective language of the different languages selected by the additional input.

15. The system of claim 1, wherein the operations comprise:
determining that the speech in the audio file is spoken in a first tone or first style;
processing the audio file by the generative machine learning model based on a prompt with an instruction to generate a new audio file with the speech spoken in a second tone or second style; and
applying the new audio file with the avatar to the generative machine learning model, wherein the animation of the avatar represents the avatar speaking the speech in the second tone or second style.

16. The system of claim 15, wherein the second tone or second style is associated with a humorous emotion different from an emotion of the first tone or first style.

17. The system of claim 15, wherein processing the audio file to generate the new audio file comprises adding, replacing, or removing one or more words spoken in the audio file to cause the speech to be spoken in the second tone or second style.

18. The system of claim 1, wherein the avatar has visual features representing the user or a friend of the user.

19. A computer-implemented method comprising:
accessing, by one or more processors, an audio file comprising speech, spoken by a user, captured by a microphone of a user system;
receiving input that selects an avatar associated with the user;
processing the audio file and the avatar, selected by the received input, by a generative machine learning model to generate an animation of the avatar having lips moving to represent the avatar speaking the speech of the audio file; and
generating a video comprising a depiction of the generated animation of the avatar speaking the speech of the audio file, the video being selectable for insertion into one or more content items.

20. A non-transitory computer-readable storage medium storing instructions that, when executed by at least one processor, cause the at least one processor to perform operations comprising:
accessing an audio file comprising speech, spoken by a user, captured by a microphone of a user system;
receiving input that selects an avatar associated with the user;
processing the audio file and the avatar, selected by the received input, by a generative machine learning model to generate an animation of the avatar having lips moving to represent the avatar speaking the speech of the audio file; and
generating a video comprising a depiction of the generated animation of the avatar speaking the speech of the audio file, the video being selectable for insertion into one or more content items.
